(19) United States
(12) Patent Application Publication
(10) Pub. No.: US 2013/0044036 A1
(43) Pub. Date: Feb. 21, 2013

(54) MIMO ANTENNA AND METHODS

(71) Applicant: Reetta Kuonanoja, Oulu (FI)

(72) Inventor: Reetta Kuonanoja, Oulu (FI)

(21) Appl. No.: 13/511,643

(22) PCT Filed: Nov. 16, 2010
(86) PCT No.: PCT/FI2010/050926

§ 371 Date: Sep. 25, 2012

(30) Foreign Application Priority Data
Nov. 27, 2009 (FI) 20096251

(51) Int. Cl. H01Q 21/00

(52) U.S. Cl. 343/810; 343/893

(57) ABSTRACT

An antenna structure that provides spatial multiplexing capabilities. In one embodiment, the antenna comprises two antenna components with a substrate and radiator, the components being located on opposite sides of the circuit board of a radio device. Each antenna component operates in combination with the ground plane of the radio device to form a partial antenna, the operating band of which is below the frequency of 1 GHz. The ground plane and the feed points of the partial antennas are arranged so that the ‘dipole axes’ of the partial antennas have clearly different directions at the frequencies of said operating band.

The invention relates to an antenna structure applying the spatial multiplexing, intended especially for small mobile stations.

The spatial multiplexing means a technique, by which the digital signal to be transmitted to a radio path is divided to at least two signals with lower rate, which signals are provided with a signature. The signals are then transmitted in the same frequency channel, each by means of an antenna of its own. The receiver, which also has more than one antenna, constructs different transmitting signals on grounds of the signatures and then combines them into the original signal. In this way the transfer capacity of the frequency channel can be increased. Optionally, the principle can be used for improving the transfer reliability by transmitting the one and the same signal with the antennas (space diversity). The spatial multiplexing will be used i.a. in the systems congruent to the LTE standard (Long Term Evolution), produced in the 3GPP (3rd Generation Partnership Project).

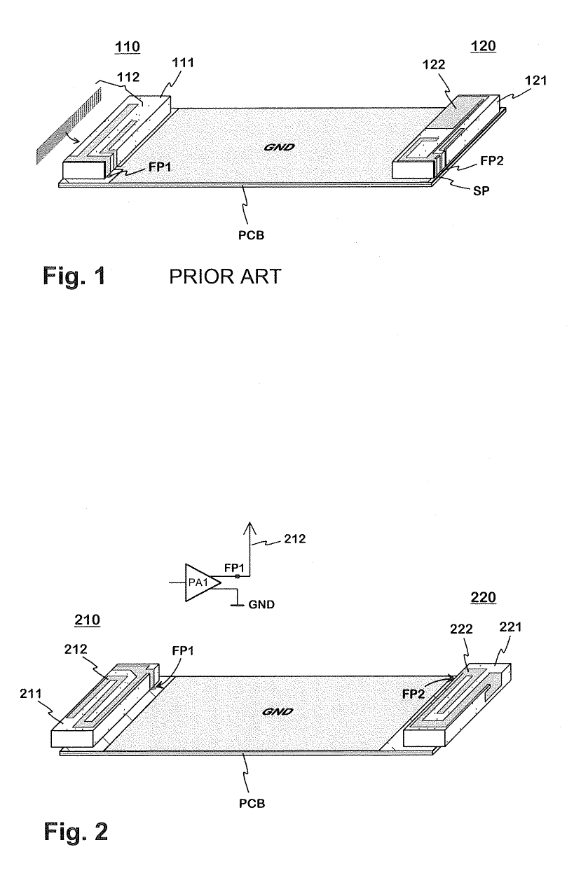

An antenna structure required in the spatial multiplexing is called MIMO antenna (Multiple-In Multiple-Out). The MIMO antenna to be described here comprises two partial antennas inside the covers of a small-sized radio device. This kind of antenna structures are not new as such. For example, FIG. 1 shows a MIMO antenna known from the article “Actual Diversity Performance of a Multiband Diversity Antenna With Hand and Head Effects” (IEEE TRANSACTIONS ON ANTENNAS AND PROPAGATION, VOL. 57, NO. 5, MAY 2009, pp. 1547-1565). It comprises a first 110 and a second 120 antenna component and the ground plane GND. Each antenna component comprises an elongated substrate and a radiator, which is of conductive coating of the substrate. The antenna components are located at the opposite ends of the rectangular circuit board PCB of a radio device so that their longitudinal direction is the same as the direction of the shorter sides of the circuit board.

The first antenna component 110 constitutes together with the ground plane GND the first partial antenna of monopole type, which includes the first radiator 112. The feed point of the first partial antenna, or the first feed point FP1, is located at an end of the antenna component 110 on the circuit board PCB close to its one long side. The first radiator 112 rises from the first feed point via the inner side surface of the first substrate 111 to the upper surface of the substrate, where it branches to a part on the upper surface and a part on the outer side surface of the substrate. The former part is for implementing the higher operating band of the antenna, and the latter, which includes a relatively dense meander portion to lower the resonance frequency, is for implementing the lower operating band of the antenna. Also a parasitic radiator is on the surface of the first substrate for shaping the higher operating band. The ground plane GND extends on the circuit board close to the first antenna component 110 so that its edge is beside the antenna component and has the same direction as the component.

The second antenna component 120 constitutes together with the ground plane GND the second partial antenna, which includes the second radiator 122. The feed point of the second partial antenna, or the second feed point FP2, is located at an end of the antenna component 120 on the circuit board PCB close to its same long side as also the first feed point. The second radiator 122 rises from the second feed point via the outer side surface of the second substrate 121 to the upper surface of the substrate, where it branches to two parts. One of these is plate-like and is for implementing the lower operating band of the antenna, and the other is for implementing the higher operating band. The second radiator is connected to the ground plane GND at the short-circuit point SP next to the second feed point FP2. The ground plane GND extends on the circuit board under the second radiator, the second partial thus antenna being of PIFA type (Planar Inverted-F Antenna). Also the second partial antenna includes a parasitic radiator for shaping the higher operating band.

A MIMO antenna naturally functions the better the less the partial antennas influence each other, or the lower the correlation between them is. The correlation again is in principle the higher the closer the partial antennas are to each other. This means a problem in small radio devices, because in them the antennas are inevitably relatively close to each other. In the multiband antennas the problem concerns particularly the lowest operating band, because at its frequencies the distance between the partial antennas in proportion to the wavelength is the shortest.

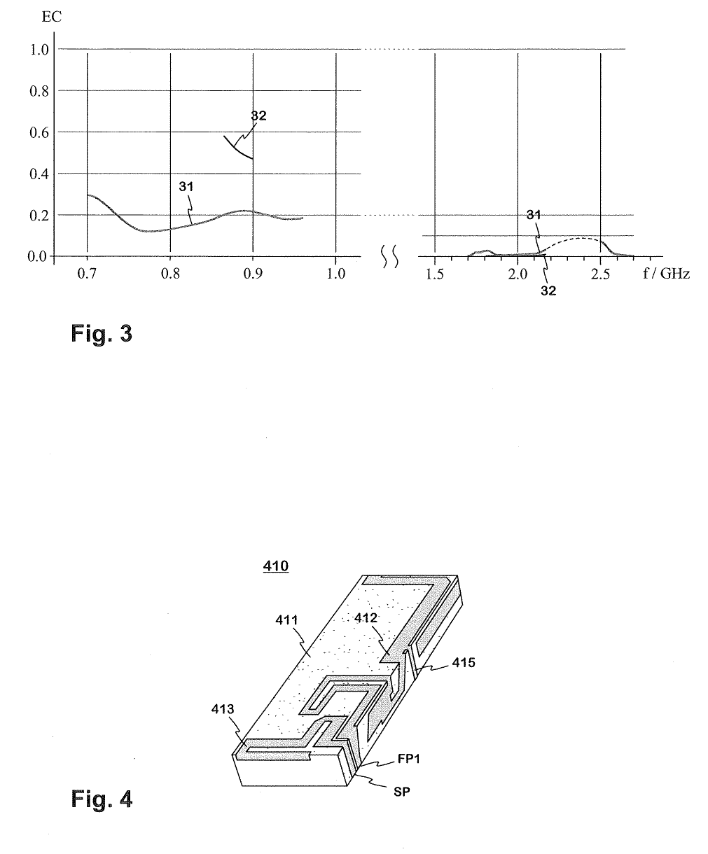

For the above-mentioned reasons also in the antenna according to FIG. 1 the correlation between the partial antennas in the lower operating band and in free space is remarkably high (FIG. 3, curve 32). The second partial antenna of the structure has been designed especially for improving diversity. Because of the effect of the user's hand the efficiency of the antenna naturally lowers. However, also the correlation lowers in the structure in FIG. 1, which matter improves the diversity gain and thus compensates the degradation of the efficiency. Nevertheless, the level of correlation between the partial antennas leaves something to be desired.

An object of the invention is to implement a MIMO antenna in a new and advantageous way. An antenna according to the invention is characterized by what is set forth in the independent claim 1. Some advantageous embodiments of the invention are disclosed in the other claims.

The basic idea of the invention is as follows: An antenna comprises two antenna components with a substrate and a radiator, the components being located on the opposite sides of the circuit board of a radio device. Each antenna component constitutes, with the ground plane of the radio device, a partial antenna, the operating band of which is below the frequency of 1 GHz. The ground plane and the feed points of the partial antennas are arranged so that the ‘dipole axes’ of the partial antennas have clearly different directions at the frequencies of said operating band. Namely, at these frequencies the partial antennas are dipole-like, the ground plane representing the other arm of the ‘dipole’.

An advantage of the invention is that the capability of a MIMO antenna of a small-sized radio device at the frequencies below 1 GHz is higher than of the corresponding known antennas. This is due to the fact that the correlation between the signals of the partial antennas is quite low because of the difference between the directions of their ‘dipole axes’.

The invention is described in closer detail in the following. In the description, reference is made to the accompanying drawings in which

FIG. 1 presents an example of the MIMO antenna according to prior art,

FIG. 2 presents an example of the MIMO antenna according to the invention,

FIG. 3 presents an example of the correlation between the signals of the partial antennas in the antenna according to the invention,

FIG. 4 presents an example of the antenna component to be used in an antenna according to the invention,

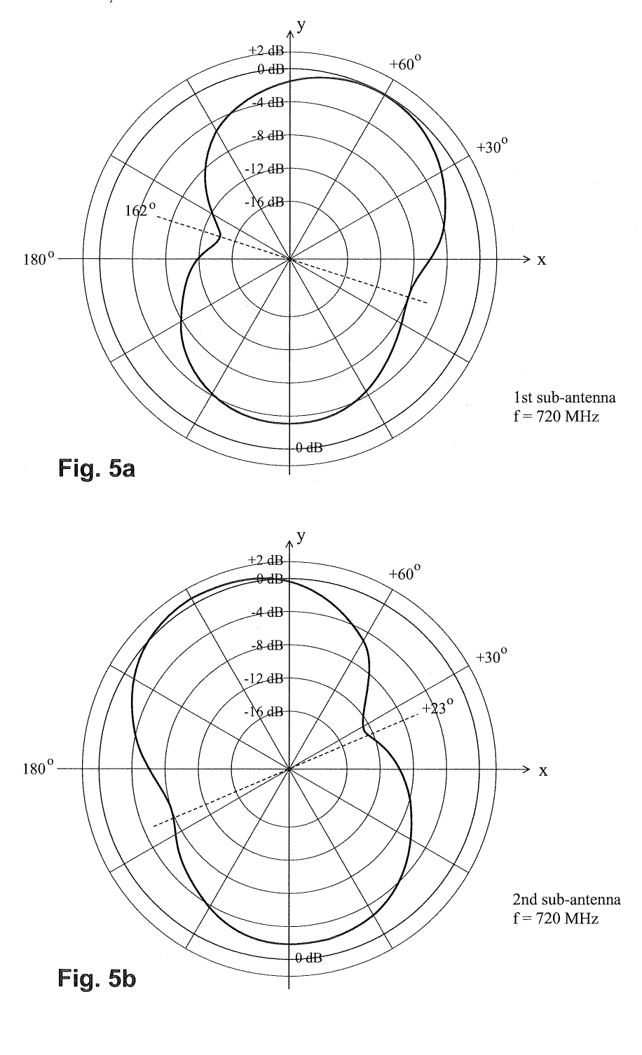

FIGS. 5a,b present an example of the radiation pattern of an antenna according to the invention,

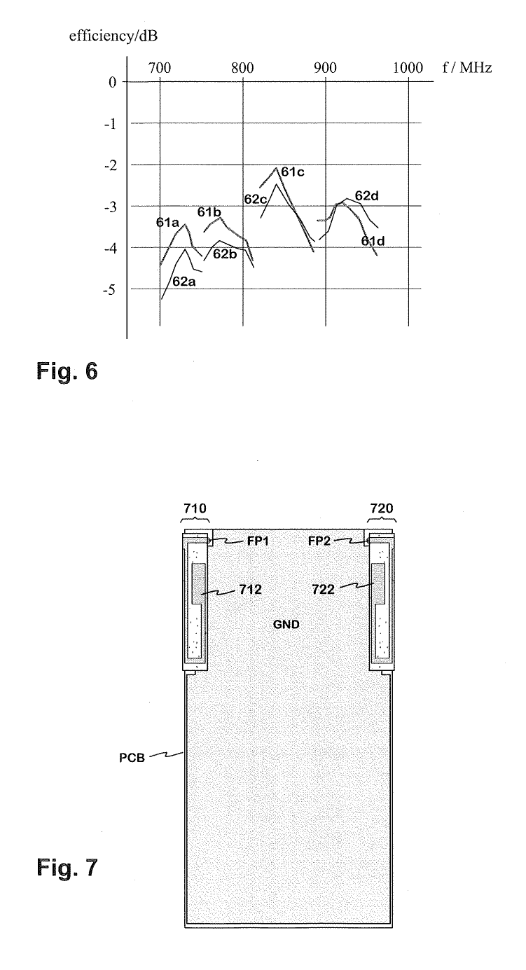

FIG. 6 presents an example of the efficiency of the antenna according to the invention and

FIG. 7 presents another example of the MIMO antenna according to the invention.

FIG. 1 was already described in connection with the description of prior art.

FIG. 2 shows an example of the MIMO antenna according to the invention. It comprises a ground plane GND and two elongated antenna components 210, 220. These are located at the opposite ends of the rectangular circuit board PCB of a radio device so that their longitudinal direction is the same as the transverse direction of the circuit board, or the direction of its shorter sides. The ground plane GND is on the circuit board between the antenna components so that it extends relatively close to the antenna components. The edge of the ground plane is then in this example at a distance from both antenna components.

The first antenna component 210 comprises the first substrate 211 and the first radiator 212, which is of conductive coating of the first substrate. The first antenna component 210 constitutes together with the ground plane the first partial antenna. The feed point of the first partial antenna, or the first feed point FP1, is located at an end of the antenna component 210 on the circuit board PCB on its one longer side, in other words, compared to the width of the circuit board, relatively close to the edge of the circuit board which corresponds to said longer side. The first radiator 212 rises from the first feed point via the inner side surface of the first substrate to the upper surface of the substrate, where it forms a certain pattern. The radiator may extend also to the outer side surface and head surfaces of the substrate.

The second antenna component 220 comprises the second substrate 221 and the second radiator 222, which is of conductive coating of the second substrate. The second antenna component constitutes together with the ground plane the second partial antenna. The feed point of the second partial antenna, or the second feed point FP2, is located at an end of the antenna component 220 on the circuit board PCB on its same longer side as also the first feed point. The second radiator rises from the second feed point via the inner side surface of the second substrate to the upper surface of the substrate, where it forms a certain pattern, extending also to the outer side surface of the substrate. The first and second radiator is designed to resonate in the same band below the frequency of 1 GHz. By shape, the radiators may be mirror images of each other in respect of the middle line between the antenna components. On the other hand, if the location of the feed points is not quite optimal, the correlation between the signals of the partial antennas can be improved, or lowered, by making their radiators to have a suitably different shape. In the example of FIG. 2, the second as well as the first radiator comprises also an arm for implementing the higher operating band of the antenna.

Above, the ‘end’ of an antenna component (and substrate) means its part, which is bounded by the head surface and is relatively short compared with the length of the component. The ‘inner’ side surface of a substrate means its side surface, which is on the side of the middle part of the circuit board PCB.

The first partial antenna and the power amplifier PA1 feeding it are shown also as a simple circuit diagram in FIG. 2. A similar diagram can naturally be drawn also for the second partial antenna.

It is substantial in the invention that the ‘dipole axes’ of the partial antennas are arranged to have clearly different directions at the frequencies of the lower operating band of the antenna, or the band below 1 GHz. In this case quite a low correlation between the signals of the partial antennas is achieved, although the distance between the partial antennas is short compared with the wavelength. The direction of a dipole axis means here the direction, where the strength of the electric field in the radiation of the dipole as if formed by the antenna radiator and ground plane is at its minimum. On the circuit board in FIG. 2 the ‘dipole axis’ of a partial antenna travels from its feed point diagonally across the ground plane. The location of the feed points of the partial antennas on the same side of the circuit board and the shape of the ground plane are factors which result in the different directions of the ‘dipole axes’. If the ground plane is very narrow, the ‘dipole axes’ position themselves too much in the same direction. Also the shape of the radiator proper has significance for the radiation pattern of the partial antenna and thus for said correlation. Namely, the route and intensity of the currents in the ground plane, which matters affect the radiation pattern formed, depend partly on the radiator.

In FIG. 3 there is an example of the correlation between the signals of the partial antennas in the MIMO antenna according to the invention. Curve 31 shows such a correlation, to be precise the envelope cross correlation, or envelope correlation EC, when the antenna is in free space. In the optimum case this correlation is zero, and the worst possible value is one. It appears from the curve that in the range of the antenna's lower operating band 700-960 MHz the correlation varies between the values 0.12 and 0.3 being less than 0.2 on average.

For comparison there is the curve 32 in FIG. 3, which shows the correlation in free space between the signals of the partial antennas in the antenna according to FIG. 1. The measurement has concerned in the lower operating band only the downlink range 869-894 MHz of the GSM850 system, in which range the correlation EC is about 0.5 on average. In the structure according to the invention it is about 0.2 in said range which is clearly better.

In the ranges of the higher operating band the envelope correlation is very low in both antennas.

FIG. 4 shows an example of the antenna component to be used in an antenna according to the invention. The antenna component 410 comprises a substrate 411 and as its conductive coating a first radiator 412 and a parasitic radiator 413. The first radiator rises from the feed point FP1 located at one end of the antenna component via a side surface of the substrate to the upper surface, makes a pattern there, returns back to the side surface then again to the upper surface and via the other head surface to the same side surface, from which it has started. Thus the first radiator constitutes a monopole antenna with the ground plane. The lower operating band of an antenna made by the component 410 is based on the resonance of the conductor of the first radiator 412. In addition, the first radiator is involved in the implementation of the higher operating band so that two radiating slots remain between its portions, which slots resonate in the higher operating band. The parasitic radiator 413 is for widening the higher operating band. It is connected to the ground plane from the short-circuit point SP located next to the feed point FP1.

An intermediate conductor 415 branches from the first radiator 412 about halfway along it, which conductor is intended to be connected to the adjusting circuit of the antenna. By means of the adjusting circuit the lower operating band of the antenna can be shifted so that it covers the frequency band currently needed.

FIGS. 5a and 5b show an example of the radiation patterns of an antenna according to the invention. The patterns concern the same antenna as the correlation curve 31 in FIG. 3. In FIG. 5a there is the radiation pattern of the first partial antenna and in FIG. 5b of the second partial antenna according to the strength of the electric field. Both of them show the radiation pattern in the plane of the circuit board, or in the xy-plane. The direction x is the longitudinal direction of the circuit board towards the second partial antenna, and the direction y is the transverse direction of the circuit board from the side of the feed points towards the opposite side. The origo is in the centre of the circuit board. Both patterns are valid in free space and at the frequency of 720 MHz When measuring one partial antenna, the other partial antenna has been connected to the 50Ω matching resistance.

Both radiation patterns have one relatively deep minimum, −13 . . . −14 dB, and another minimum in the opposite direction. The angle between the ‘dipole axes’ drawn through the minimums is 162°-23°, or about 140° (or its complement 40°). Thus, the directions deviate clearly from each other, which is a benefit when minimizing the correlation.

FIG. 6 shows an example of the efficiency of an antenna according to the invention. The adjustable antenna mentioned in the description of FIG. 4 is in question, in which antenna the lower operating band can be set to four different place inside the whole range of 700-960 MHz. Curves 61a, 61b, 61c and 61d show the fluctuation of the efficiency of the first partial antenna in these four alternative ranges of the lower operating band. Correspondingly curves 62a, 62b, 62c and 62d show the fluctuation of the efficiency of the second partial antenna in said alternative ranges. The efficiency is the best, when the range 820-880 MHz has been chosen and the worst, when the range 700-760 MHz has been chosen. The total fluctuation in the efficiency of the first partial antenna is about −4.3 to −2.1 dB, and the total fluctuation in the efficiency of the second partial antenna is about −5.3 to −2.5 dB. The values are valid in free space.

FIG. 7 shows another example of the MIMO antenna according to the invention. It comprises a ground plane GND and two elongated antenna components 710, 720. In this case these are located at the same end of the circuit board PCB of a radio device, on the opposite longer sides of the circuit board. Thus the longitudinal direction of the antenna components is the same as the longitudinal direction of the circuit board. The ground plane is on the circuit board between the antenna components extending in this example under the antenna components.

The first antenna component 710 comprises a substrate and the first radiator 712, which is of its conductive coating. The first antenna component constitutes together with the ground plane GND the first partial antenna. Its feed point, or the first feed point FP1, is located at an end of the antenna component 710 on the circuit board PCB, on the side of the inner side surface of the antenna component. Correspondingly the second antenna component 720 comprises a substrate and the second radiator 722, which is of its conductive coating. The second antenna component constitutes together with the ground plane the second partial antenna.

Its feed point, or the second feed point FP2, is located at an end of the antenna component 720 on the circuit board PCB, on the side of the inner side surface of the antenna component. In FIG. 7 both feed points are located on one shorter side of the circuit board, in other words, relatively close to the edge of the circuit board which corresponds to said shorter side.

The radiators are here mirror images of each other so that the first radiator 712 is by shape a mirror image of the second radiator 722 in respect of the plane, which has the direction of the longitudinal direction of the second antenna component 720 and is perpendicular to the circuit board. This feature is preferable especially in this case, when the antenna components are located considerably closer to each other than in the example of FIG. 2.

A MIMO antenna according to the invention has been described above. In details, its structure can naturally differ from what is presented. The shapes of the radiating elements can vary greatly. A radiator can also be connected to the ground so that, instead of a monopole antenna, an IFA (Inverted-F Antenna) or a loop antenna is formed. The antenna components do not have to be exactly parallel and located precisely at the edge of the circuit board. The circuit board does not have to be precisely rectangular. The invention does not limit the way of manufacturing of the antenna. The inventive idea can be applied in different ways within the scope set by the independent claim 1.

1.-8. (canceled)

9. An antenna for use in a radio device, comprising:
a first antenna element comprising a first feed point, a first substrate portion and a first radiator;
a second antenna element comprising a second feed point, a second substrate portion and a second radiator; and
a ground plane disposed substantially between said first and second antennas;
wherein the first and second antenna elements are located on opposing sides of an antenna substrate with the first and second feed points being located proximate a same edge of the antenna substrate.

10. The antenna of claim 9, wherein the first feed point is located proximate an end of the first antenna element, and the second feed point is located proximate an end of the second antenna element.

11. The antenna of claim 10, wherein both the first and second antenna elements have an operating band below a frequency of 1 GHz.

12. The antenna of claim 10, wherein the antenna substrate comprises a circuit board that has a longitudinal dimension and a transverse dimension, the transverse dimension being shorter in length than the longitudinal dimension, and wherein a longitudinal dimension of each of said first and second substrate portions has an orientation that is substantially the same as the transverse direction of the circuit board.

13. The antenna of claim 10, wherein the antenna substrate comprises a circuit board that has a longitudinal dimension and a transverse dimension, the transverse dimension being shorter in length than the longitudinal dimension, and wherein a longitudinal dimension of each of said first and second substrate portions has a length that is substantially the same as the transverse direction of the circuit board.

14. The antenna of claim 9, wherein the antenna substrate comprises a circuit board that has a longitudinal dimension and a transverse dimension, the transverse dimension being shorter in length than the longitudinal dimension, and wherein the same edge of the circuit board comprises an edge of a longitudinal side of the circuit board.

15. The antenna of claim 9, wherein the circuit board is elongated so that it has a longitudinal and transverse dimension, wherein a longitudinal dimension of said first and second antenna elements is substantially parallel with said transverse dimension of the circuit board.

16. The antenna of claim 9, wherein the first radiator comprises a substantially mirror image shape of the second radiator at least with respect to a plane that is parallel with the antenna substrate.

17. The antenna of claim 9, wherein the first and second antenna elements comprise monopole antennas.

18. The antenna of claim 17, further comprising an adjusting circuit in electrical communication with said first radiator and configured to enable setting of the operating band of the first antenna element in a desired operating range.

19. The antenna of claim 18, further comprising a second adjusting circuit in electrical communication with said second radiator an configured to enable setting of the operating band of the second antenna element in a desired operating range.

20. The antenna of claim 17, wherein the first and second radiators are shaped to resonate in the frequency range on the order of about 2 GHz to implement a higher operating band for the antenna.

21. An antenna, comprising:
a substantially planar substrate;
a first antenna component disposed in a first region of the substrate; and
a second antenna component disposed in a second region of the substrate;
wherein the first and second antenna components are further disposed such that a dipole axis of the first antenna component is substantially different in orientation from a dipole axis of the second antenna component.

22. The antenna of claim 21, wherein the substrate is substantially rectangular in shape and has first and second ends, and the first region is disposed at or near the first end of the of the substrate, and the second region is disposed at or near the second end.

23. The antenna of claim 21, wherein the first and second antenna components comprise first and second partial radiator elements, respectively, each of the first and second partial radiator elements configured to radiate in at least a common frequency band.

24. The antenna of claim 23, wherein first and second feed points associated with the first and second antenna components, respectively, are both disposed proximate a common edge of substrate, and interior to the first and second antenna components, respectively.

25. The antenna of claim 21, wherein first and second feed points associated with the first and second antenna components, respectively, are both disposed proximate a common edge of substrate, and interior to the first and second antenna components, respectively.

26. A compact form-factor radio device, comprising:
at least one wireless transceiver;
a multiple input multiple output (MIMO) antenna in signal communication with the at least one transceiver, the antenna comprising:
a substantially planar substrate;
a first antenna component disposed in a first region of the substrate; and
a second antenna component disposed in a second region of the substrate;
wherein the first and second antenna components are further disposed such that a dipole axis of the first antenna component when operating at a frequency below 1 GHz is substantially different in orientation from a dipole axis of the second antenna component when operating at a frequency below 1 GHz; and
a compact form factor housing substantially enclosing the at least one transceiver and the antenna.

27. A multiple input multiple output (MIMO) antenna, comprising:
a substantially planar substrate;
a first antenna component disposed in a first region of the substrate; and
a second antenna component disposed in a second region of the substrate;
wherein the first and second antenna components are further disposed relative said substrate and each other such that a radio frequency correlation of the first antenna component with the second antenna component in at least a first frequency band is minimized.

28. The antenna of claim 27, wherein the correlation comprises at least one of: (i) a cross-correlation; and/or (ii) an envelope correlation, measured in free space.

29. The antenna of claim 28, wherein the first frequency band comprises a band below 1 GHz.

30. An antenna of a radio device, comprising:
a first antenna component with a first substrate and a first radiator;
a second antenna component with a second substrate and a second radiator; and
a ground plane between said first and second antenna components;
wherein said first antenna component constitutes with the ground plane a first partial antenna which has a first feed point, and the second antenna component constitutes with the ground plane a second partial antenna which has a second feed point;
wherein both the first and second partial antennas have an operating band below the frequency of 1 GHz, with the first and second antenna components located on different sides of a circuit board of the radio device in order to lower the correlation between the signals of the partial antennas; and
wherein said feed points are located on the same side of the circuit board, the first feed point at an end of the first antenna component and the second feed point at an end of the second antenna component so as to further lower the correlation between the signals of the partial antennas in said operating band.

31. The antenna of claim 30, in which said circuit board is elongated so that it has a longitudinal and transverse direction, wherein the longitudinal direction of said antenna components is substantially the same as the transverse direction of the circuit board, and said side of the circuit board, on which the feed points of the partial antennas are located comprises a longitudinal side of the circuit board.

32. The antenna of claim 30, in which said circuit board is elongated so that it has a longitudinal and transverse direction, wherein the longitudinal direction of said antenna components is substantially the same as the longitudinal direction of the circuit board, and said side of the circuit board, on which the feed points of the partial antennas are located, is a transverse side of the circuit board.

33. The antenna of claim 30, wherein the first radiator comprises a mirror image shape of the second radiator in respect of the plane which has the direction of the longitudinal direction of the second antenna component and is perpendicular to the circuit board.

34. The antenna of claim 30, wherein the partial antennas are monopole antennas.

35. The antenna of claim 34, wherein each partial antenna further comprises an adjusting circuit connected to said radiator to set said operating band in a range currently needed.

36. The antenna of claim 34, wherein said radiators are shaped to resonate also in the frequency range of the order of 2 GHz to implement a higher operating band for the antenna.

37. The antenna of claim 34, wherein the partial antennas further comprise a parasitic radiator to widen a higher operating band.
